(19) United States
(12) Patent Application Publication
(10) Pub. No.: US 2009/0031211 A1
(43) Pub. Date: Jan. 29, 2009

(54) PROGRAMMING EXTENSION FOR AUTHORING STYLE RULES

(76) Inventors: Yitao Yao, Saratoga, CA (US); Matthew Jaquish, San Jose, CA (US); Mark P. Palaima, Saratoga, CA (US); Paul Flynn, Mountain View, CA (US); Francis Smith, San Jose, CA (US); David William Dodd, Sunnyvale, CA (US); Richard Ragan, Mountain View, CA (US)

Correspondence Address: SCHWEGMAN, LUNDBERG & WOESSNER/EBAY, P.O. BOX 2938, MINNEAPOLIS, MN, 55402, US

(21) Appl. No.: 12/103,866

(22) Filed: Apr. 16, 2008

Related U.S. Application Data
(60) Provisional application No. 60/961,622, filed on Jul. 23, 2007.

(51) Int. Cl. G06F 17/00

(52) U.S. Cl. 715/234

(57) ABSTRACT

A programming extension for authoring style rules is provided. An example programming extension for authoring style rules comprises a style rules editor and a style definition class module. An example style rules editor may be configured to receive a request to generate a collection of style rules and to receive input associated with one or more style rules. The requested collection of style rules is to be suitable for use with a document-based web page. The style definition class module may be configured to generate a Java™ representation of the collection of style rules based on the input associated with the one or more style rules.

### RELATED APPLICATIONS

This application claims the priority benefits of U.S. Provisional Application Ser. No. 60/961,622, filed Jul. 23, 2007 which is incorporated herein by reference in its entirety.

### TECHNICAL FIELD

This application relates to electronic commerce in general and Cascading Style Sheets (CSS) programming extension in particular.

### BACKGROUND

In web development, Cascading Style Sheets, often abbreviated as CSS is a style language used to describe presentation of a document written in a markup language such as an eXtensible Markup Language (XML). A common application of CSS is to style web pages written in HTML and XHTML. CSS may also be utilized with any XML document. Example uses of CSS include defining colors, fonts, layout, and other aspects of document presentation. CSS allows to separate the content of a document (e.g., written in HTML) from the document presentation (written in CSS).

### BRIEF DESCRIPTION OF DRAWINGS

Embodiments of the present invention are illustrated by way of example and not limitation in the figures of the accompanying drawings, in which like reference numbers indicate similar elements and in which:

FIG. 1 is a diagrammatic representation of a network environment within which an example style rules authoring platform may be implemented;

FIG. 2 is an example architecture illustrating processing a request for a web page that references style rules, in accordance with one example embodiment;

FIG. 3 is a block diagram of a cascading style rules authoring platform, in accordance with an example embodiment;

FIG. 4 is a flow chart of a method to process a request to generate a collection of style rules, in accordance with an example embodiment;

FIG. 5 illustrates a standard IDE used to provide CSS coding assistance; and

FIG. 6 is a diagrammatic representation of an example machine in the form of a computer system within which a set of instructions, for causing the machine to perform any one or more of the methodologies discussed herein, may be executed.

### DETAILED DESCRIPTION

Cascading Style Sheets (CSS) gain increasing attraction with WEB 2.0. However, its programming style and process often present manageability issues, especially for larger commercial applications. One of the deficiencies of CSS identified by the inventors is lack of formal programming language support. Existing solution do not provide a CSS authoring application programming interface (API) or a CSS application API.

The raw text-based authoring, simply based on the CSS specification, even with advanced structure editor, may present a variety of issues. For example, text-based authoring typically lacks context-sensitive help with auto-completion. There is no programming reference model readily available during the authoring stage or during the application of a collection of style rules (e.g., there is no typed programming API to reference a specific rule within a CSS file). Due to the lack of referencing programming model, an author of a CSS file may need to clone, create, or alter style rules manually. For example, in order to create a family of rules (e.g., rules with same selectors but with different property values) the author may have to cut and paste rules from one text file into another. Such manual process may be prone to errors and time consuming. Since the property values in a CSS text file have to be in their final string format, the text-based authoring and editing of CSS presents difficulties where it may be desirable to reference externally defined data types.

In one example embodiment, a CSS programming extension is configured to enhance usability of CSS programming. A server-side CSS programming extension, in an example embodiment of a CSS authoring API, may be provided to emulate a higher level programming language, such as Java™. (Java™ is a trademark of Sun Microsystems, Inc.) A CSS authoring API may be implemented as a Java™ class that defines CSS rules in a Java™ object. One example embodiment of such Java™ class will be referred to as a Style Definition Class (e.g., named as JCssDef). The abstract JCssDef class, in one embodiment, provides a friendly authoring environment for defining specific CSS. An instance of CSS may be represented by an extended sub-class of base JCssDef.

A Style Definition Class, in one example embodiment, provides a set of complete programming APIs that may be used in any Java™ Integrated Development Environment (IDE) that provides context-sensitive help and auto-completion coding assistance. A Style Definition Class may be configured to include selector features to aid the authoring process. Table 1 below shows some example selector constructs using JCssDef. With predefined/configured tags and basic association functions, one can easily built various complex selectors.

TABLE 1

| | Example JCssDef Selector API | |
|---|---|---|
| CSS Syntax | usage | Meaning |
| div | div | div HTML tag |
| div span | div.desc(span) | A span which is a descendant of |
| | | a div. |
| p.foo table | p.with(Clz.foo).desc(table) | A table which is a descendant of |
| | | a p with a class named “foo.” |
| div > span | div.child(span) | A span that is a child of a div. |
| div#foo>span.bar | div.with(ID.foo).child(span.with(Clz.bar)) | A span with a class name of |
| | | “bar” that is a child of a div with |
| | | a id name of “foo.” |
| td + td | td.sibb(td) | A td that is a following sibling |
| | | to any td. |
| div.foo+div.bar | div.with(Clz.foo).sibb(div.with(Clz.bar)) | A div with a class name of “bar” |
| | | that is the following sibling of a |
| | | div with a class name of “foo.” |
| a:active | a.pseudoActive( ) | Active links. |
| div:after | div.pseudoAfter( ) | Insert content after the element. |
| div:before | div.pseudoAfter( ) | Insert content before the |
| | | element. |
| div:first-child | div.pseudoFirstChild( ) | Select element when it's the first |
| | | child. |
| h4:first-letter | h4.pseudoFirstLetter( ) | Select first letter of the |
| | | element's content. |
| p:first-line | p.pseudoFirstLine( ) | Select first line of element's |
| | | content. |
| div:focus | div.pseudoFocus( ) | Select when element has focus. |
| a:hover | a.pseudoHover( ) | Link that is hovered over. |
| div:lang(en-US) | div.pseudoLang(“en-US”) | Select based on language. |
| a:link | a.pseudoLink( ) | Normal link state. |
| a:visited | a.pseudoVisited( ) | Links that have been visited. |

The list below shows example tags defined by Style Definition Class.
Abbr; acronym; address; any; applet; area; big; blockquote; body; br; button; caption; center; cite; code; col; colgroup; dd; del; dfn; dir; div; dl; dt; em; fieldset; font; form; frame; frameset; h1; h2; h3; h4; h5; h6; hr; html; iframe; img; input; ins; isindex; kbd; label; legend; li; map; menu noframes; noscript; object; ol; optgroup; option; pre; q; s; samp; select; small; span; strike; strong; sub sup; table; tbody; td; textarea; tfoot; th; thead; tr; tt; u; ul; var.

Example Style Definition Class may be configured to have typed property definition methods in order to help eliminate the need for developer to remember the exact spelling of property names. Furthermore, enumerations may be provided for most of the standard CSS property values. this approach may be utilized advantageously by persons without extensive CSS expertise. The list and Table 2 below show some example property types and value enumerations.
BackgroundAttachment; BackgroundColor; BackgroundPosition; BackgroundRepeat; BaseCssPropBorder; BorderCollapse; BorderColor; BorderStyle; BorderWidth; Bottom; CaptionSide; Clear; Color; Content; Cursor; Direction; Display; EmptyCells; Float; Font; FontFamily; FontSize; FontStyle; FontVariant; FontWeight; Left; Length; LetterSpacing; LineHeight; ListStyle; ListStyleimage; ListStylePosition; ListStyleType; OutlineColor; Overflow; PageBreakAfter; PageBreakBefore; PageBreakInside; Position; QuotesRight; TableLayout; TextAlign; TextDecoration; TextTransform; Top; UnicodeBidi; VerticalAlign; Visibility; WhiteSpace; Width; WordSpacing; ZIndex.

TABLE 2

| | |
|---|---|
| BackgroundPosition | BOTTOM BOTTOM_LEFT |
| | BOTTOM_RIGHT CENTER |
| | INHERIT LEFT RIGHT |
| | TOP TOP_LEFT TOP_RIGHT |
| BackgroundRepeat | TOP_RIGHT NO_REPEAT REPEAT |
| | REPEAT_X REPEAT_Y |
| BorderStyle | DASHED DOTTED DOUBLE GROOVE |
| | HIDDEN INHERIT INSET |
| | NONE OUTSET RIDGE |
| | SOLID |

The property API of an example Style Definition Class may permit both typed enumeration values and raw string values. Table 3 below shows example property API for a single property—an example “background” property. The properly overloaded methods may make CSS authoring more user-friendly.

TABLE 3

| | |
|---|---|
| JCssProperties | background(com.ebay.dsf.javatocss.prop.Background background) |
| JCssProperties | background(com.ebay.dsf.javatocss.prop.Background background, boolean |
| | important) |
| JCssProperties | background(com.ebay.dsf.javatocss.prop.BackgroundColor color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | com.ebay.dsf.javatocss.prop.BackgroundPosition position) |
| JCssProperties | background(com.ebay.dsf.javatocss.prop.BackgroundColor color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | com.ebay.dsf.javatocss.prop.BackgroundPosition position, |
| | boolean important) |
| JCssProperties | background(com.ebay.dsf.javatocss.prop.Color color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | com.ebay.dsf.javatocss.prop.BackgroundPosition position) |
| JCssProperties | background(com.ebay.dsf.javatocss.prop.Color color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | com.ebay.dsf.javatocss.prop.BackgroundPosition position, |
| | boolean important) |
| JCssProperties | background(java.lang.String background) |
| JCssProperties | background(java.lang.String background, |
| | boolean important) |
| JCssProperties | background(java.lang.String color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | com.ebay.dsf.javatocss.prop.BackgroundPosition position) |
| JCssProperties | background(java.lang.String color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | com.ebay.dsf.javatocss.prop.BackgroundPosition position, |
| | boolean important) |
| JCssProperties | background(java.lang.String color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | java.lang.String position) |
| JCssProperties | background(java.lang.String color, |
| | com.ebay.dsf.resource.image.ImageId image, |
| | com.ebay.dsf.javatocss.prop.BackgroundRepeat repeat, |
| | com.ebay.dsf.javatocss.prop.BackgroundAttachment attachment, |
| | java.lang.String position, |
| | boolean important) |

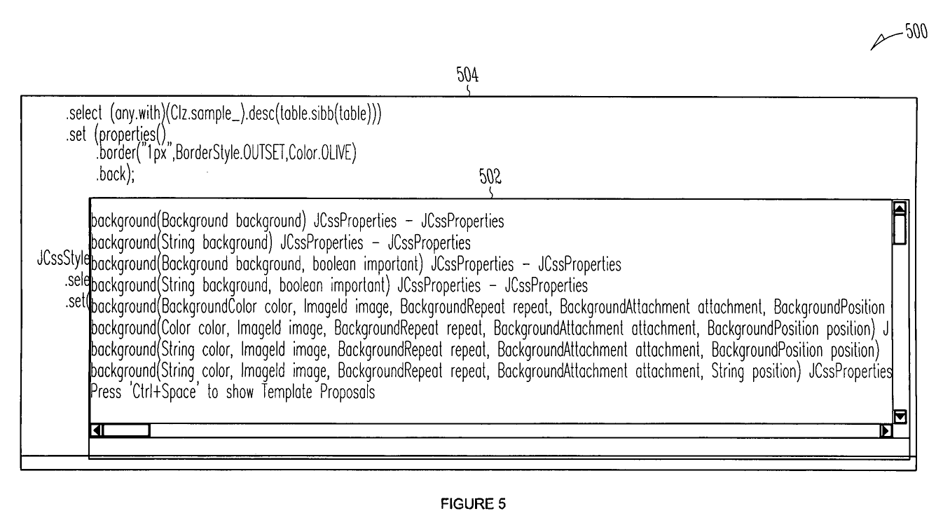

A standard IDE may be used to provide coding assistance as illustrated in FIG. 5. In one example embodiment, an IDE may be provided with a plug-in (a so-called JCssDef-aware IDE plug-in). An IDE 500 illustrated in FIG. 5 is shown to include an assistance window 502 overlaying a main work area 504. In FIG. 5, the IDE 500 responds with the JCssDef-aware IDE plug-in providing possible resolutions of the term “back” in the assistance window 502 when the term “back” that was entered in the main work area 504 cannot be resolved into a known property name.

The property API of the Style Definition Class, in one example embodiment, allows referencing of variables outside of the CSS definition, as well as variables from other Style Definition Class instances. The property API of the Style Definition Class may also provide value binding support to use external reference that can be resolved to different values based on environmental permutations. For example, an image reference can be used directly in style definition without the need to take its possible permutations into consideration. The final value, e.g., a universal resource locater (URL) of image could be properly resolved to be a localized image with proper protocols (such as, e.g., HTTP or HTTPs) based on its permutation.

For example, the definition in one Style Definition Class instance shown as Example 1 below may be resolved to the definition shown as Example 2 below, to localized images for a different locale (e.g., DE) shown in Example 3 below, or to secure images for secure pages shown in Example 4 below.

### EXAMPLE 1

```
rule( ).select(div.with(Clz.example_).desc(table.sibb(table)))
.set( properties( )
    .border(“1px”,BorderStyle.OUTSET,Color.OLIVE)
    .backgroundImage(pics.aboutme.disney.feature_gif));
```

### EXAMPLE 2

div.example table+table {border:1px outset olive; background-
image:url(http://pics.ebaystatic.com/aw/pics/aboutme/disney/feature.gif)

### EXAMPLE 3

div.example table+table {border:1px outset olive; background-
image:url(http://pics.ebaystatic.com/aw/pics/de/aboutme/disney/feature.gif)

### EXAMPLE 4

div.example table+table {border:1px outset olive; background-image:url(
https://securepics.ebaystatic.com/aw/pics/aboutme/disney/feature.gif)

In one example embodiment, each rule in a Style Definition Class object may be programmatically referenced within or outside the Style Definition Class object, which, in turn, may contribute to easier cloning, altering, or extension of style rules. The style rules defined utilizing an example CSS programming extension may be scoped automatically (e.g., with late-binding), based on the operating environment, in order to confine the applicable matching range for the selectors.

For example, the rule shown in Example 6 below may produce the text form of CSS shown in Example 7 below and may be referred to as a scoped style rule.

### EXAMPLE 6

```
JCssStyleRule RULE1 = instance.rule( )
    .select(div.with(Clz.title_))
    .select(p.desc(h4))
    .set( properties( )
        .fontWeight(FontWeight.BOLDER)
        .color(Color.BLUE));
```

### EXAMPLE 7

div.title, p h4 {font-weight:bolder; color:blue

Another scoped style rule, shown in Example 8 below, may be configured to constrain its usage without the need to know its internal selectors and properties. The style rule shown in Example 8 below may produce the text form of CSS shown in Example 9 below.

### EXAMPLE 8

JCssStyleRule RULE2=instance.rule(RULE1, ID.abc_);

### EXAMPLE 9

#abc div.title, #abc p h4 {font-weight:bolder; color:blue}

In some embodiments, rules in a Style Definition Class instance may be defined as override rules over the inherited ones. For example, RULE3 inherits from RULE2 with same selectors (both shown in Example 10 below. RULE3 also overrides the color value and adds new font properties. The text form of CSS corresponding to the Style Definition Class instance shown in Example 10 is shown in Example 11 below.

### EXAMPLE 10

```
JCssStyleRule RULE3 = instance.rule(RULE2)
    .set( properties( )
    .color(Color.RED)
    .fontSize(FontSize.X_LARGE));
```

### EXAMPLE 11

#abc div.title, #abc p h4 {color:blue; font-size:x-large}

A Style Definition Class may be defined to correspond to a collection of Cascading Style Sheets (or CSS files). For example, such collection may include several localized versions of style definitions. In one embodiment, an appropriate localization instruction in a Style Definition Class instance may be invoked to return the requested localized set of style rules.

A Style Definition Class, in one example embodiment, supports more general permutation concepts. A permutation is a way to describe locale and target variations. For instance, fr_FR and en_US_AUTOS can represent different permutations. A JCssDef always has a DEFAULT permutation that is shared and inherited for all permutations.

A example instance of Style Definition Class in Example 12 below shows a DEFAULT section applicable to all permutations (locales), while fr_FR section provides override of default rule, and defines new rule.

### EXAMPLE 12

```
public interface DEFAULT {
    JCssStyleRule RULE1 = instance.rule( )
        .select(div.with(Clz.title_))
        .select(p.desc(h4))
        .set( properties( )
          .fontWeight(FontWeight.BOLDER)
          .color(Color.BLUE));
}
public static abstract class fr_FR {
  static {
  properties(DEFAULT.RULE1).padding(“20px”).background(“#FFF”);
  }
  static final JCssStyleRule RULE_X = instance.rule( )
      .select(div.with(Clz.title_).desc(div))
      .set( properties( )
      .width(“50%”)
      .floatCss(Float.LEFT));
}
```

The instance of a Style Definition Class shown in Example 12 produces the text form of CSS for fr_FR shown in Example 13 below and the text form of CSS for de_DE shown in Example 14 below.

### EXAMPLE 13

div.title, p h4 {font-weight:bolder; color:blue; padding:20px;
background:#fff}
div.title span {width:50%; float:left}

### EXAMPLE 14

div.title, p h4 {font-weight:bolder; color:blue}

As mentioned above, a Style Definition Class, in one example embodiment, is an active programming construct with extended capability that is beyond the capability of a raw text-based CSS file. For example, in a typical web application, a CSS id or class used by CSS definition may need to be set as an HTML attribute, and it may also need to be referenced by JavaScript. Using the Style Definition Class approach described herein, a constant can be defined externally and referenced by different parts of the system. When the value of that constant changes, there is no need to search every text files for making corresponding string replacement.

Furthermore, in one example embodiment, in component-based development environment, an application may be a composition of multiple pre-existing components that may have their associated CSS. With traditional text-based CSS definition, it may be difficult to automatically resolve the name conflict between different components. For example, different components on the system may select the same CSS id or class value at definition time. To address the issue, an example Style Definition Class may provide the ID reservation system for designer to choose proper values in its own name space in order to avoid name conflict. Each local ID reservation system may further retrieve its name scope and apply the name scope to the values handed out by the local ID reservation system.

For example, an id value “title” may be reserved from a local reservation instance. At runtime, a scope name, e.g., the term “buying,” may be applied to this reservation instance. Then the final resolved value may become “buying-title.” The scoping mechanism may resolve the conflict between this “title” and a “title” from another reservation instance, which can have different scoped name assigned to it at runtime.

As also shown in one example embodiment, the style rule override feature in Style Definition Class may contribute to avoiding the need for text-based cut and paste operations. When a style rule changes its selectors, any inherited or overridden rules may reflect the change automatically.

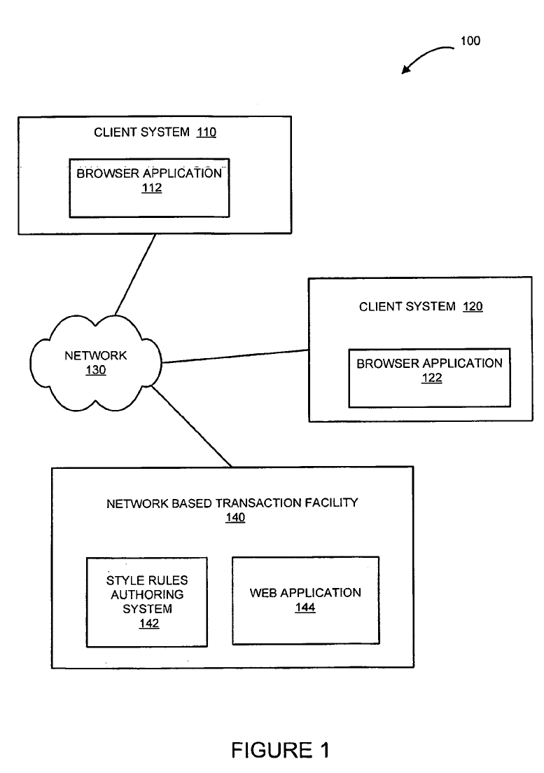

Additionally, in some example embodiments, a plug-in may be provided with an IDE that can auto-generate a Style Definition Class from a CSS file and vise versa. An example programming extension for authoring style rules may be implemented in the context of a network environment, which may be discussed with reference to FIG. 1.

As shown in FIG. 1, a network environment 100 may include client systems 110 and 120 and a network-based transaction facility 140. The client systems 110 and 120 may host respective browser applications 112 and 122 and may have access to the network-based transaction facility 140 via a communications network 130. The communications network 130 may be a public network (e.g., the Internet, a wireless network, etc.) or a private network (e.g., a local area network (LAN), a wide area network (WAN), Intranet, etc.).

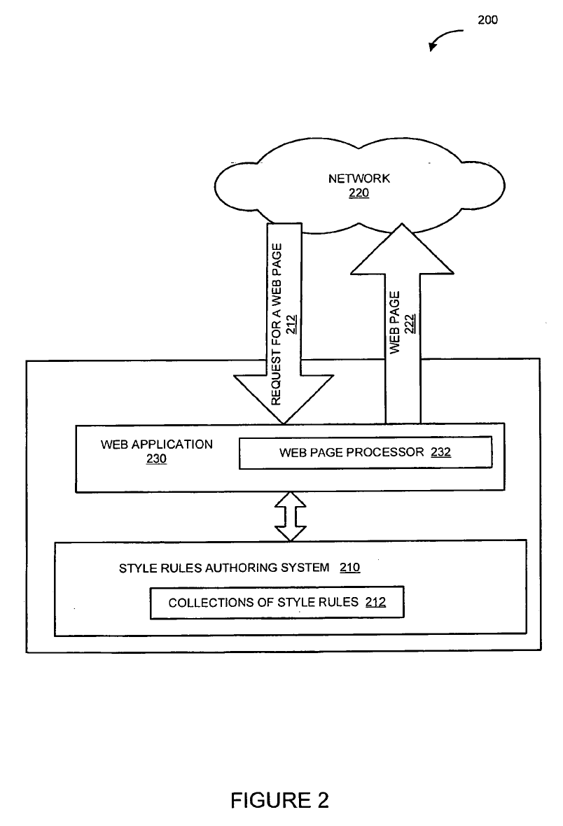

The client system 110 may utilize the browser application 112 to access services provided by the network-based transaction facility 140. The services provided by the network-based transaction facility 140 may employ a style rules authoring system 142 that may be used to generate a Java™ representation of style rules that, in turn, may be used in a manner similar to using Cascading Style Sheets. In one embodiment, the network-based transaction facility 140 may be hosted by a web server. An architecture illustrating example use of the style rules authoring system 142 may be described with reference to FIG. 2.

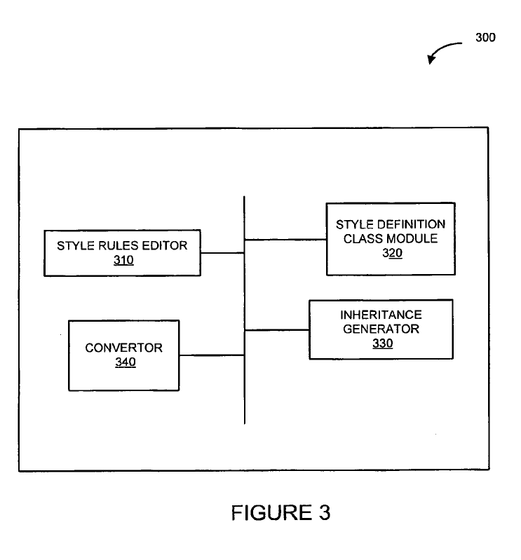

An architecture 200 shown in FIG. 2 includes a web application 230 that receives requests 212 for web pages from a network 220 and, in return, provides the requested web pages 222 back to the network 220. As shown in FIG. 2, the web application 230 may cooperate with a style rules authoring system 210 to obtain style rules and associate the style ruled with web pages. The style rules authoring system 210, in one example embodiment, includes a storage module that may include a collection of style rules 232. Some of the modules of the web application 230 that may be configured to receive and process network requests (e.g., from browser applications) for web pages may be collectively referred to as a web page processor 212. An example web page processor 232 is illustrated as part of the web application 230. When a request for a dynamic web page is received by the web application 230 and the web application 230 determines that access to the collection of style rules 232 is required, the requested style rules are retrieved and provided to the requesting browser application together with the web page 222. An example style rules authoring system 210 may be used to provide a Java™ representation of style rules suitable for use with document-based web pages may be described with reference to FIG. 3.

FIG. 3 is a block diagram of a style rules authoring system 300 that may be implemented to be deployed with a Java™ Integrated Development Interface, in accordance with one example embodiment. As shown in FIG. 3, the style rules authoring system 300 includes a style rules editor 310, a style definition class module 320, an inheritance generator 330, and a convertor 340. The style rules editor 310 may be configured to permit a user to initiate a style rules authoring session, to provide input that may be utilized to create style rules, and to save a collection of style rules generated based on the user input. The style rules editor 310 may be configured to cooperate with the style definition class module 320 module to generate Java™ representation of the style rules. As mentioned above, the style rules authoring system 300 may provide an inheritance feature for each style rule in a collection of style rules. When the style rules editor 310 detects an indication that a style rule is to be inheritable (e.g., by virtue of a user selection an associated command in the style rules editor 310), the inheritance generator 330 may be invoked to configure the rule as an inheritable rule.

In some embodiments, the style rules authoring system 300 may be configured to permit a user to create a collection of style rules “from scratch,” e.g., by monitoring user input and generating an associated Java™ representation for each rule. The style rules authoring system 300 may also include a mechanism, e.g., the converter 340, to receive a Cascading Style Sheets (CSS) file and convert the CSS file into a Style Definition Class object. The converter 340 may be configured to also receive a Style Definition Class object and, based on the Style Definition Class object, generate a corresponding CSS file.

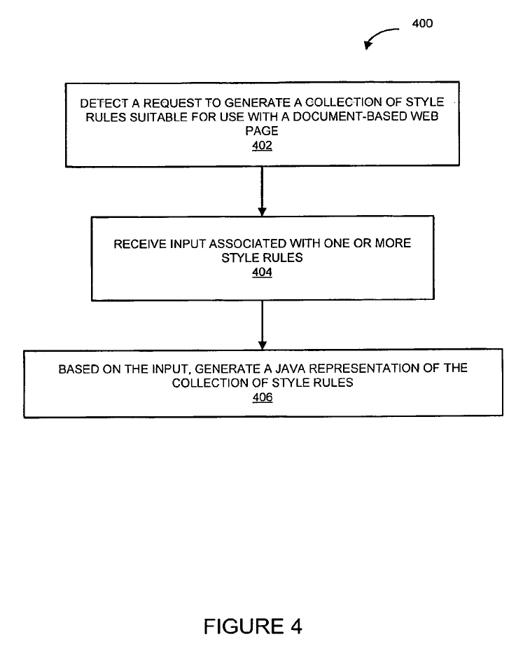

An example method to author style rules utilizing a rules authoring system can be described with reference to FIG. 4. FIG. 4 is a flow chart of a method 400 to generate a collection of style rules, according to one example embodiment. The method 400 may be performed by processing logic that may comprise hardware (e.g., dedicated logic, programmable logic, microcode, etc.), software (such as run on a general purpose computer system or a dedicated machine), or a combination of both. In one example embodiment, the processing logic resides at the transaction processing system 140 of FIG. 1 and, specifically, at the style rules authoring system 142. In another example embodiment, the processing logic may be distributed between various servers at the network based transaction facility 140 of FIG. 1.

As shown in FIG. 4, the style rules editor 310 of FIG. 3 detects a request to generate a collection of style rules suitable for use with a document-based web page at operation 402. The style rules editor 310 may then receive input associated with one or more style rules, at operation 404. At operation 406, the style definition class module 320 generates Java™ representation of the collection of style rules based on the input.

The JCssDef base class, in one example embodiment, provides various APIs for authoring a style sheet. For any JCssDef instance that extends JCssDef, a Java IDEs may automatically provide code assistance for choosing the proper methods and properties with auto-completions, as discussed above with reference to FIG. 5.

In addition, JCssDef-aware IDE plug-in may be configured to help bootstrap the JCssDef instance creation. For a given CSS text file, the plug-in can generate a corresponding JCssDef instance. For each rule defined in JCssDef, the plug-in can also generate corresponding style rule text for visual inspection.

In one example embodiment, a JCssDef instance can be referenced by any Java program to retrieve the CSS text for a given permutation. The resulting CSS text is resolved based on given conditions. For example, CSS id and class may have be scoped; images may be resolved based on its locale, request protocol (secure or non-secure) and environment (testing or production, etc); rules may be aggregated based on the JCssDef instance permutation, such as locale and targets.

A collection of JCssDef instances may be aggregated to produce final CSS text for an application to be consumed at runtime. For example, a properly generated CSS text section can be directly embedded into a web page when application responds a user's request.

The aggregated CSS text can also be prepared in advance via build process. Pre-generated CSS files (e.g., vectored based on all permutations) can be versioned and deployed into a file serving sub-system. When an application receives the user requests, it can reference pre-deployed CSS files in its generated web pages, e.g., via a style link.

It will be noted that while example implementation details are described above, various other techniques may be utilized in further embodiments. In one example embodiment, a machine-readable medium is provided having instruction data to cause a machine to receive a request to generate a collection of style rules, the collection of rules being suitable for use with a document-based web page, receive input associated with one or more style rules, and to generate a Java™ representation of the collection of style rules based on the input associated with the one or more style rules.

Machine readable medium will be understood as a medium that is capable of storing data in a form that can be accessed by an automated sensing device. Examples of machine-readable media include magnetic disks, cards, tapes, and optical disks, as well as other forms of volatile and non-volatile memory devices.

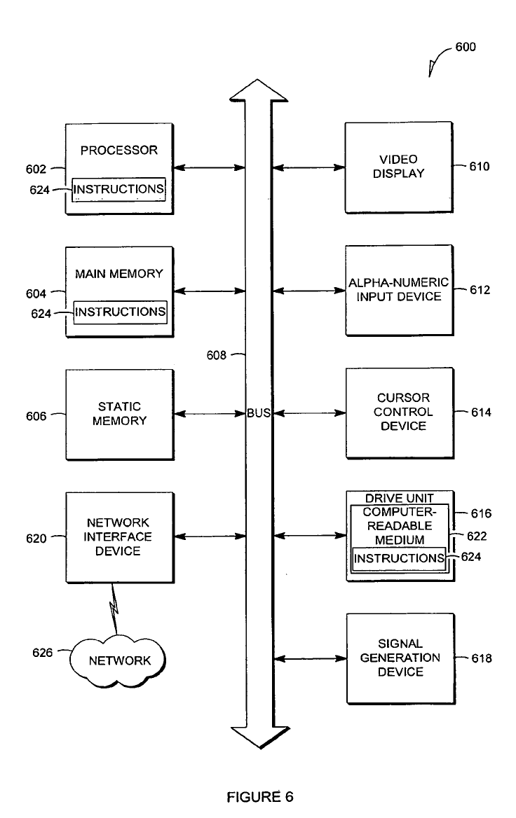

FIG. 6 shows a diagrammatic representation of a machine in the example form of a computer system 600 within which a set of instructions, for causing the machine to perform any one or more of the methodologies discussed herein, may be executed. In alternative embodiments, the machine operates as a stand-alone device or may be connected (e.g., networked) to other machines. In a networked deployment, the machine may operate in the capacity of a server or a client machine in a server-client network environment, or as a peer machine in a peer-to-peer (or distributed) network environment. The machine may be a personal computer (PC), a tablet PC, a set-top box (STB), a Personal Digital Assistant (PDA), a cellular telephone, a web appliance, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 600 includes a processor 602 (e.g., a central processing unit (CPU), a graphics processing unit (GPU) or both), a main memory 604 and a static memory 606, which communicate with each other via a bus 608. The computer system 600 may further include a video display unit 610 (e.g., a liquid crystal display (LCD) or a cathode ray tube (CRT)). The computer system 600 also includes an alpha-numeric input device 612 (e.g., a keyboard), a user interface (UI) navigation device 614 (e.g., a cursor control device), a disk drive unit 616, a signal generation device 618 (e.g., a speaker) and a network interface device 620.

The disk drive unit 616 includes a machine-readable medium 622 on which is stored one or more sets of instructions and data structures (e.g., software 624) embodying or utilized by any one or more of the methodologies or functions described herein. The software 624 may also reside, completely or at least partially, within the main memory 604 and/or within the processor 602 during execution thereof by the computer system 600, with the main memory 604 and the processor 602 also constituting machine-readable media.

The software 624 may further be transmitted or received over a network 626 via the network interface device 620 utilizing any one of a number of well-known transfer protocols (e.g., Hyper Text Transfer Protocol (HTTP)).

While the machine-readable medium 622 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of embodiments of the present invention, or that is capable of storing, encoding or carrying data structures utilized by or associated with such a set of instructions. The term “machine-readable medium” shall accordingly be taken to include, but not be limited to, solid-state memories, optical and magnetic media, and carrier wave signals. Such media may also include, without limitation, hard disks, floppy disks, flash memory cards, digital video disks, random access memory (RAMs), read only memory (ROMs), and the like.

The embodiments described herein may be implemented in an operating environment comprising software installed on a computer, in hardware, or in a combination of software and hardware.

Thus, a programming extension for authoring style rules has been described. Although embodiments have been described with reference to specific example embodiments, it will be evident that various modifications and changes may be made to these embodiments without departing from the broader spirit and scope of the inventive subject matter. Accordingly, the specification and drawings are to be regarded in an illustrative rather than a restrictive sense.

1. A system comprising:
a style rules editor to:
receive a request to generate a collection of style rules, the collection of rules being suitable for use with a document-based web page, and
receive input associated with one or more style rules; and
a style definition class module to generate a Java™ representation of the collection of style rules based on the input associated with the one or more style rules.

2. The system of claim 1, wherein the Java™ representation of the requested collection of style rules is a Java™ class.

3. The system of claim 1, including an inheritance module to configure a style rule from the collection of style rules as an inheritable object.

4. The system of claim 1, wherein the collection of style rules is a resource of a web application.

5. The system of claim 1, wherein the input associated with the one or more style rules is a user input.

6. The system of claim 1, wherein the input associated with the one or more style rules is a text file.

7. The system of claim 6, wherein the text file is a cascading style sheets file.

8. The system of claim 1, wherein the Java™ representation of the collection of style rules is associated with one or more localized versions of the collection of style rules.

9. The system of claim 1, including a converter, the converter being to generate cascading style sheets file based on the Java™ representation of the collection of style rules.

10. The system of claim 8, including a dependencies generator to configure a style rule from the collection of style rules as an inheritable object.

11. A method comprising:
receiving a request to generate a collection of style rules, the collection of rules being suitable for use with a document-based web page;
receiving input associated with one or more style rules; and
based on the input associated with the one or more style rules, generating a Java™ representation of the collection of style rules.

12. The method of claim 11, wherein the Java™ representation of the requested collection of style rules is a Java™ class.

13. The method of claim 11, wherein a style rule from the collection of style rules is an inheritable object.

14. The method of claim 11, including referencing the collection of style rules as a resource.

15. The method of claim 11, wherein the input associated with the one or more style rules is a user input.

16. The method of claim 11, wherein the input associated with the one or more style rules is a text file.

17. The method of claim 16, wherein the text file is a cascading style sheets file.

18. The method of claim 11, wherein the Java™ representation of the collection of style rules is associated with one or more localized versions of the collection of style rules.

19. The method of claim 11, comprising:
associating a web page with Java™ representation of the collection of style rules; and
providing the web page to a user application.

20. A machine-readable medium having instruction data to cause a machine to:
receive a request to generate a collection of style rules, the collection of rules being suitable for use with a document-based web page;
receive input associated with one or more style rules; and
generate a Java™ representation of the collection of style rules based on the input associated with the one or more style rules.
